(19) United States
(12) Patent Application Publication
(10) Pub. No.: US 2017/0019409 A1
(43) Pub. Date: Jan. 19, 2017

(54) SYSTEM AND METHOD FOR ACCESS CONTROL VIA SOCIAL NETWORKING

(71) Applicant: OPEN GARDEN INC., San Francisco, CA (US)

(72) Inventors: Stanislav Shalunov, Lafayette, CA (US); Gregory Hazel, San Francisco, CA (US); Micha Benoliel, San Francisco, CA (US)

(21) Appl. No.: 14/759,033

(22) PCT Filed: Apr. 2, 2015
(86) PCT No.: PCT/US2015/024173

§ 371 Date: Jul. 2, 2015

Related U.S. Application Data
(60) Provisional application No. 61/974,434, filed on Apr. 2, 2014.

(51) Int. Cl. H04L 29/06; H04W 12/08

(52) U.S. Cl. CPC H04L 63/102; H04L 63/108; H04W 12/08

(57) ABSTRACT

Systems and methods to grand network access to devices. When device attempts access via an access point, the AP initiates social network inquiry to determine whether to provide unrestricted access, restricted access or no access, depending on the social connection between the user and the AP owner. The social network inquiry may be performed by obtaining a social graph from services such as Facebook, LinkedIn, etc. The social network inquiry may also be performed by interrogating a calendar, to determine whether an appointment is indicated for the user associated with the device requesting the access and a user associated with the access point. The social network inquiry may also be performed by interrogating a database to determine whether a specific entry is present, e.g., whether a predetermined “like” is included in lists of “likes” in the Facebook account of the user associated with the device requesting the access.

### RELATED APPLICATIONS

This Application claims priority benefit from U.S. Provisional Application Ser. No. 61/974,434, filed on Apr. 2, 2014, the disclosure of which is incorporated herein by reference in its entirety.

### BACKGROUND

1. Field

This disclosure relates to access and authorization of computing devices onto wireless networks.

2. Related Art

Wireless routers have become ubiquitous as a cost-effective way of creating local wireless (e.g. Wi-Fi) networks within limited physical areas, typically encompassing a residence or business. These routers (whether wired or wireless) are sometimes referred to as access points (AP), as they provide a point of access to the Internet or an intranet. Throughout this disclosure the use of router, wireless router, access point and AP, may be considered to be interchangeable.

Wireless networks offer an easy and convenient way for any Wi-Fi-capable device to connect to the Internet, but require some administrative management. Typically when installing the router, the network owner must decide whether to secure the network or leave it unsecured, i.e. whether or not to require a password, and if so, to choose a password. In some installations, a password is desirable, since bandwidth is a limited resource for which the network owner pays, and leaving the network unsecured opens the network to outsiders (who happen to be nearby) to use it without incurring any expense. On the other hand, some businesses, for example, coffee houses, may choose to simply leave the network open so its customers can enjoy Internet connectivity while sipping their coffee, without having to bother the barista for the password. This situation raises a number of unresolved issues which present opportunities for new wireless network management tools to solve.

One issue relates to permissions for accessing wireless networks. When a house guest attempts to use a private wireless network, he or she must obtain a password from the host, unless the network is open and unsecured. This is fraught with difficulties, as the network owner must do one of the following: divulge to the guest the secured password; open the network completely; create a one-time username and password; or deny internet access altogether. The first option can itself be difficult, if not impossible. Often home network owners don't remember their passwords. It might be written down somewhere, but difficult or impossible to find. Other members of the household may likely not know the password, or where to find it. If the password isn't available, the remaining options listed above are each undesirable. Opening the network presents security issues and requires known the admin password, not to mention the problem of incurring network abuse or performance degradation resulting from unknown users who happen to be within Wi-Fi range (wireless networks in general, not specifically Wi-Fi). Creating single-use credentials is cumbersome. Even if the password is available, it may be undesirable to expose it permanently.

A similar problem arises when visiting a company or other organization. Opening a network for free and unrestricted access is unpalatable to most organizations, since it costs bandwidth and invites abuse. Exposing the network password is not acceptable for security reasons. Issuing one-time passwords is good security practice, but one-time passwords are difficult to generate and manage for network administrators, and cumbersome for visitors, since such generated passwords are typically 16 character strings consisting of a random sequence of upper and lower letters, numerals, and special characters, and because each visit to an organization requires a new such password. Using such a system typically requires hiring people to install and manage it; their time and effort is expensive.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Various disclosed embodiments utilize social network to organize wireless network access permissions. The embodiments can replace the standard password login procedure using a social network-based authentication. Additionally, rules and policies can be included in and enforced by the social network-based authentication.

If, in the above scenario of someone visiting the home of a friend, the host and guest are friends on a social network, for example, they are Facebook friends, the system, which includes a Facebook app can recognize this friendship and automatically give the guest authorization to access his host's network. From users' perspective, social networking allows very simple and straightforward provisioning of access using information that users already have provided elsewhere; and, from network's perspective, we allow, if necessary limited network access to, say, Facebook, so that the user can approve the authenticating app's access to his personal info, without giving full Internet access until the device has been authenticated.

The scope of this disclosure is fundamentally applicable to any wireless (or wired) technology. It is therefore not restricted to Wi-Fi, but includes WiMax, Bluetooth, and any other potential successor technologies to Wi-Fi that require authorization to use. The disclosed embodiments replace cumbersome manual processes for authentication and access control with a cloud-based service that provides identity and access control based on the social network identity and social graph of user. In this respect, social network may referred to services such as Facebook, LinkedIn, Google+, and meeting services such as Outlook, WebEx, Lync, etc.

Aspects of the invention provide systems and method to grant network access to devices. When a device attempts to gain access via an access point, the access point initiates a social network inquiry to determine whether to provide unrestricted access, restricted access, or no access, depending on the social connection between a user associated with the device requesting the access and a user associated with the access point, e.g., the router owner. The social network inquiry may be performed by obtaining a social graph from services such as Facebook, LinkedIn, etc. The social network inquiry may also be performed by interrogating a meeting service, such as a calendar, WebEx, Lync, etc., to determine whether an appointment is indicated for the user associated with the device requesting the access and a user associated with the access point. The social network inquiry may also be performed by interrogating a database to determine whether a specific entry is present, e.g., whether a predetermined “like” is included in lists of “likes” in the Facebook account of the user associated with the device requesting the access, whether a “check in” operation was performed from the specific establishment, e.g., using GPS coordinates, etc.

Aspects of the disclosed embodiments include a method for automatically providing secure wireless network access to a user, comprising the steps of: receiving at a router a request for access from a wireless device of the user; sending the request from the router to an authorizing server; at the authorizing server performing identity authentication to determine that the user is who he says he is and, if the identity of the user is authenticated, performing access authorization check to determine whether the user should be authorized to access the router; and, receiving at the router a response from the authorizing server and, when the response is an authorization, granting access to the user, but when the response is denial, denying access. The authorization server may perform a social network inquiry to determine identity authentication and/or whether to authorize the request for access. The authorization server may also send an authorization request to an owner of the router. The identity authentication may be performed by checking whether the user can logon to a social network account. If so, the access authorization can be checked by determining the social connection of the social network account to the router's owner account. The method may further include, after authenticating the user, saving a cookie in the user indicating that the user has been authenticated, and on subsequent requests for network access, by passing the authentication step using information stored in the cookie.

Aspect of disclosed embodiment also provide methods for initializing a wireless router by a network owner, comprising the steps: when the user initially logs on to the router, directing the user to an authorization server; using the authorization server to accesses a social network server and requesting the user to logon to its account on the social network server. Optionally, when the owner is logged in, enabling the owner to establish rules and policies to manage authentication and access control of users. Also, once the owner logs into the social network account, associating the social network account with the router so as to recognize and authenticate the identity of the network owner and automatically allow him to use the router upon subsequent attempts without the need for the owner to enter a password.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1A is a schematic illustrating operation of one disclosed embodiment exemplified in Use Case 1, relating to obtaining network access at a friend's house, while FIG. 1B is a flow chart of a process carried out in FIG. 1A.

FIG. 2A is a schematic illustrating operation of another disclosed embodiment, exemplified as Use Case 2, relating to obtaining network access at a friend's house, while FIG. 2B is a flow chart of a process carried out in FIG. 2A.

FIG. 3A is a schematic illustrating operation of another disclosed embodiment, exemplified as Use Case 4, relating to wireless device accesses a café's router, while FIG. 3B is a flow chart of a process carried out in FIG. 3A.

FIG. 4A is a schematic illustrating operation of another disclosed embodiment, exemplified as Use Case 8, relating to a user attending a meeting, having been invited through an online calendar system, while FIG. 4B is a flow chart of a process carried out in FIG. 4A.

### DETAILED DISCLOSURE

Various disclosed embodiments enable easy and mostly automatic authorization and connection to a network access point, such as a WiFi access point. The disclosed embodiments enable maintaining a secure network which requires a password for connectivity, but the system enables automatic connection even without knowledge and entry of the password. The features and benefits of the invention can be best understood from the following detailed description of various embodiments and examples.

### System Architecture

According to one embodiment, the system that implements access control consists of an application (app) that runs on an authentication server that provides the access control service. Various web-based services, such as social network Facebook and other social networks, provide APIs that enable developers to access available services, such as the social graph for Facebook, programmatically. These APIs have been revised and have evolved over time. It is not essential to use any one particular such API, as long as the API offers access to the social graph. Therefore, the app uses any of the APIs provided by services such as Facebook that give access to the social graph. One such API, most often used at the time of this writing, is Facebook Connect. It is the same API that enables the “Login with Facebook” feature found on many websites as an alternative method to register for, or log into a web service. In a similar way, for each of the other social networks or meeting services, the system uses the API provided by that service to access that social network's social graph.

Note that in this scenario, Facebook is merely an illustrative example. The social network could just as easily be LinkedIn, Google+, Weibo, WeChat, VKontakte, or any other social network based either in the U.S. or in another country. In one embodiment, a version of the app is provided for each social network used. The social network can provide a mechanism to authenticate identity and/or to control access. By providing identity authentication, it means the ability to determine that a user is who he says he is. An identity provider is a network service that offers this ability. The term “identity” has different meanings in different contexts. For example, identity on Yahoo is the user name, while identity on Facebook is the account. E-mail addresses may serve as a form of identity in some contexts, but not in others—Google+ and Twitter, for example, do not use e-mail addresses. In addition to social networks, there are other identity providers that are not social networks, for example Yahoo and Google (excluding Google+).

Network owners may choose the social network or identity provider they consider most appropriate. For example, LinkedIn may be the preferred choice of a company inviting potential employees to an informational meeting; homeowners and cafés will likely prefer Facebook; news organizations may opt for Twitter; Spotify or Pandora may be the choice for a symposium on performance practices of the Baroque era, and so on. Network owners may also attach and enforce terms and conditions on the use of their networks, so for example, the use of a public library's Wi-Fi network may require users to be library members in good standing.

Just as social networks enable this embodiment, the embodiment also benefits social networks, since when guests want to access a network, they will be required to join the social network to use the network. This serves to increase the membership of the social network.

One feature of the disclosed embodiments is to employ a social network as an identity provider to permit a network owner to establish rules and policies that govern network access. The general approach, in high level terms, is as follows.

When a network owner installs a router, he configures this system. Instead of choosing a wireless router password, he is directed to an authorization server running the app described above, which then accesses the social graph using the appropriate social network's API. Using this app, he logs in to establish rules and policies to manage authentication and access control. This app may recognize and authenticate the identity of the network owner and automatically allow him to use his own home Wi-Fi without the need for the owner to enter a password. Alternatively, it is also possible that only the guests use this feature, and the owner configures his own access to require a password. Nevertheless, the owner needs to associate his social network account with the router so as to enable others to log in to the router, and optionally to establish rules and policies.

When a guest attempts to access a web page via the owner's router, the network detects the HTTP request and redirects the browser to the access authorization server, where the app, in turn, uses the social network-provided API to access that social network's social graph. This gives the app the ability to authenticate the user's identity and to determine and enforce the rules and policies that the network owner has established. For example, one rule might be to simply give access to guests who are friends of the network owner on the social network. The rules may be more complex, as the use cases below indicate.

Before describing the use cases, note that the system according to the disclosed embodiments provides these and further advantages:
The system is easy for the network owner to set up and manage, since he does not need to remember a password, or distribute it to guests.
The system is convenient for guests, since they are automatically granted access without the need for typing in a password.
The system is secure, since it effectively has the benefit of one-time disposable passwords without having to manage such a system. This is far more secure than relying on human-chosen (and therefore, often poorly chosen) passwords.
The system offers greater flexibility, since the network owner can selectively offer different categories of guests access to selected network resources (for example, file servers and printers) in addition to simply controlling Internet access.
The system access control is enforced automatically, without requiring any manual network administration to approve access.

The following are use cases that give examples of the nature and scope of the kinds of policies a network owner might establish.

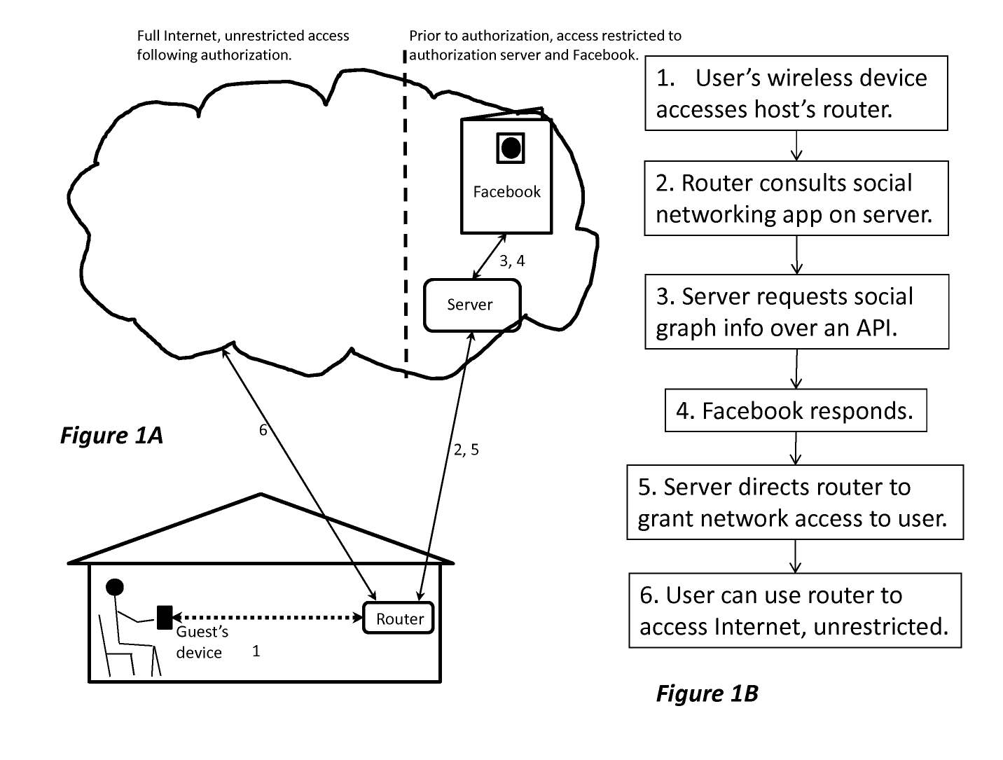

Use Case 1: The scenario and process exemplified by Use Case 1 are illustrated in FIGS. 1A and 1B. John (guest) visits the home of his friend Sally (AP owner). John and Sally are friends on Facebook. Sally has configured her network to permit her Facebook friends automatic access to her home network. When John attempts to use her network, his initial HTTP request redirects to a Facebook app (running on authorization servers), which checks that Sally and John are friends on Facebook (using the Facebook API provided for this purpose). Note that at this point John has access to only the part of the network that is to the right of the vertical broken-line in FIG. 1A, i.e., only to the authorization server—which itself has access to the Facebook server via an API. Since they are Facebook friends, the access app gives John unrestricted access to the network, which he can then use freely, i.e., access to the left side of the vertical broken-line in FIG. 1A.

The login process may proceed as follows. In Step 1 of FIG. 1B, John's (the guest) wireless device accesses Sallys' (the host's) router. The network router intercepts the HTTP requests from John's wireless device and issues an HTTP response with status code 301 or 302 redirect to an entry-point to the Facebook app, as illustrated in Step 2. As illustrated in Step 3, upon receiving the redirect request from the router, the authentication server requests the social graph information from the Facebook server, over an API. In step 4, the Facebook server sends the requested social graph information to the authentication server. If the social graph indicates that indeed John is a Facebook friend of Sally, in Step 5 the authentication server sends an authorization instruction to the router, granting John access to the router. The router may send an indication to John's device, informing John that he now has unrestricted access to the network, i.e., the Internet or an intranet, exemplified in Step 6.

Facebook users are typically always logged into Facebook. If this is true of John, and if he previously used the system, then the system already has access to everything that the system needs to verify John's identify (e.g., through the use of cookies), so the process can proceed transparently, i.e. the system can direct Sally's router to immediately give network access to John without challenging John to provide credentials. That is, under these circumstances the authentications step is performed using cookies, without the involvement of John, and the authorization step makes use of the automatic authentication results. This is possible because cookies persist across browser sessions. Optionally, a splash screen is sent to John's device, welcoming him to Sally's network, if Sally chooses that behavior.

If John has not previously used the system, then the system needs to authenticate that the request indeed comes from John's device. This can be done by, for example, having the system ask John to log into Facebook to prove that he can access his profile. This presents John with a screen requesting that he log into Facebook to give the app access his profile, including his friend list.

This demonstrates the two distinct steps the system uses:

1. Authenticating to Facebook (proving to Facebook that he is the specified user).

2. Give the system permission to access his profile.

If he's previously logged into Facebook and hasn't cleared his cookies, then the first step is unnecessary. Since most users are logged into Facebook most of the time, and if they have previously used the system, it is possible to provide an entirely transparent experience in the sense that the user isn't even aware that the system is providing them with authentication since the whole process is automatic—unless, at the network owner's discretion, a splash screen is displayed to inform the user that he has been authenticated and now has network access.

This process also works in situations where the user has previously used the system on a different network. The authentication is performed for a user. Being user-specific, rather than network-specific, the system can authenticate from any network. The system can still show him a splash screen that says “welcome to Sally's network.” If the user is logged into Facebook and has previously authorized the app, the process can be made entirely transparent, so he has same experience as if he typed the password.

If John is not a member of Facebook, this screen offers him the option of registering. After John is authenticated, e.g., may be on Facebook or on a dedicated domain name having been redirected by Facebook, the app on the server then accesses John's Facebook account using the Facebook API. Once this app, using this API, verifies that John (the guest) and Sally (the network owner) are Facebook friends, the app then uses HTTPS (or possibly SSH or some other proprietary protocol) to send an out-of-band message to Sally's router that instructs the router to allow network access. The router may identify John by MAC address or in any other way that the wireless network supports, to give John permission to access Sally's network for a specified period of time. The app could either tell the router this time duration, or the app could send a message to the router at end of time period to direct the router to revoke John's network access.

This router functionality may be achieved by updating the router firmware, or by using the services of a firm such as OpenWRT that sells custom routers. A third possibility is to use routers that have enough features so that no change to the firmware is required. A fourth possibility is to make specifically designed router.

By whatever method is used to achieve this router functionality, the router uses the “captive portal” technique to redirect browser requests to a web page that requests authentication. The router may even be pre-loaded with this web page or configured to route to a particular webpage on a server. In this use case, John is presented with a page that requests him to enter his Facebook account credentials (if he is not currently logged in, as discussed above), but in other contexts, this might be a request for payment, acceptance of terms and conditions, the credentials of another social network, payment, or some combination of these.

Once authenticated, the Facebook app can be implemented according to either of these two examples:
a. The user accesses Facebook, then Facebook pulls content from the authorization server. Facebook does not store the content the user sees. Instead it comes from the authorization server.
b. The user communicates with the authorization server, which then interacts with Facebook, using an appropriate Facebook API.

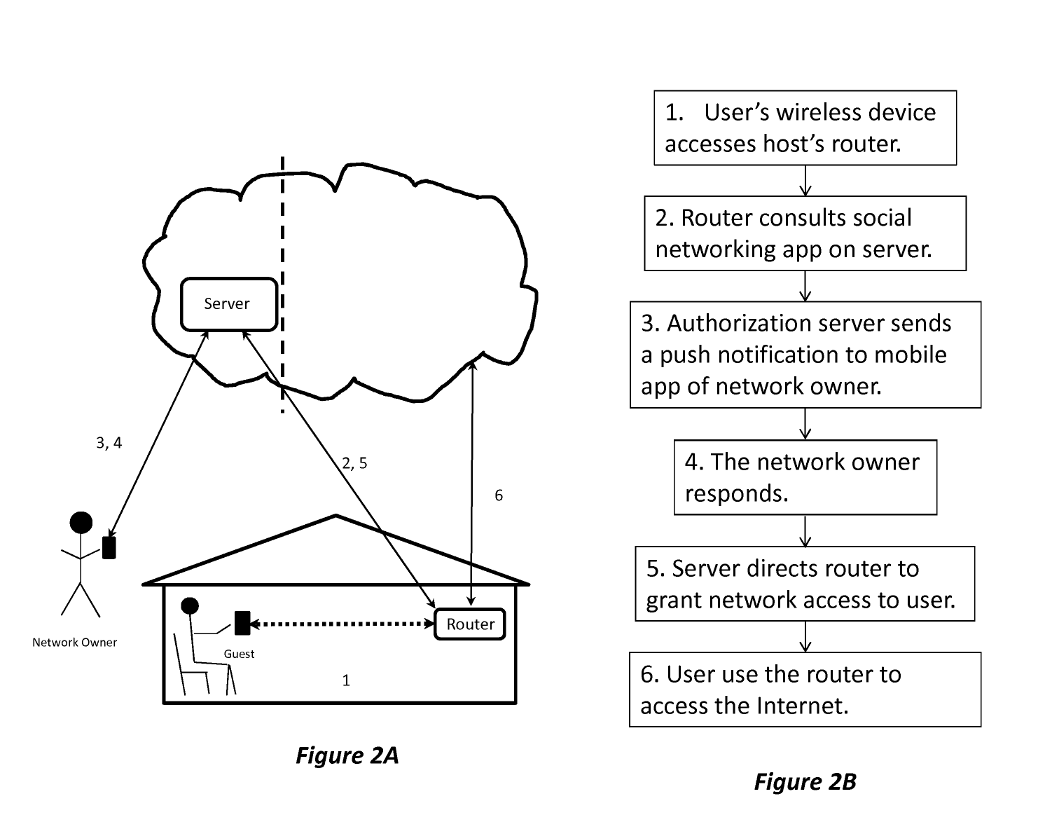

Use Case 2: The scenario and process exemplified by Use Case 2 are illustrated in FIGS. 2A and 2B. In Step 1 of FIGS. 2A and 2B, the guest, Bob, attempts to use the home network of Alice, the network owner and a Facebook friend of Bob's Facebook friend, without prior explicit authorization from Alice. In Step 2 the router transmits Bob's connection request to the authorization server. The authorization system has various interfaces, among which is an interface enabling the system to talk to the network owner—Alice. Specifically, the authentication system includes an app, e.g., a client, which is installed on Alice's mobile device, and which has the ability to receive push notifications. In Step 3, the server sends Alice, the network owner, a push notification, which she receives on her mobile device and offers her a choice of approving or denying network access to Bob. If in Step 4 Alice permits Bob to use her network, the app may also let Alice specify policies and/or the time duration for which Bob's network access is granted. Then, in Step 5 the authorization server sends a response to the router, providing authorization to allow access to Bob, according to the policies and time limit indicated by Alice. In Step 6 the router grants the access to Bob, optionally sending Bob's mobile device an indication to that effect to be displayed on Bob's mobile device.

In this use case, the technical details differ from Use Case 1. In this case, the server sends a push notification to the network owner, which wakes up mobile app (client) on the network owner's mobile device. The mobile app displays a user interface that shows the owner who requests to use her network. The network owner can then respond by selecting whichever option he or she prefers and specifying the time duration for which to grant access. The app on the mobile device then sends a message to the app on the server directing it to grant access for the specified period. From that point, the system proceeds as in Use Case 1.

It should be noted that the processes of Use Case 1 and Use Case 2 are not mutually exclusive. That is, the authorization system may have the capabilities of both Use Case 1 and Use Case 2 simultaneously, and execute either of the processes depending on pre-programmed policies. According to one implementation, upon a login attempt by a user, the system may be pre-programmed to analyze the type of login attempt and to follow the procedure of Use Case 1 or Use Case 2 according to the type of login attempt. For example, if the guest attempts to connect to the system using its Facebook credentials, the system may proceed to interrogate the Facebook server as explained in Use Case 1, while if the user attempts to login using its LinkedIn credentials the system may be pre-programmed to send a notification to the network owner, as in Use Case 2. As another example, if the user attempts to login, the system may ask the user to logon to its Facebook account. If the user logs on, authentication may proceed as in Use Case 1, but if the user doesn't login, authentication may proceed according to Use Case 2. Many other examples may be used.

Use Case 3: Bill attempts to use Barbara's home network, but Bill and Barbara, while both may be members of Facebook, they do not have a Facebook friendship relationship. In this case, the system asks Bill to enter his (i.e., the Guest) name and the e-mail address of the network owner into a user interface that the app displays on Bob's device (in the manner described above in Use Case 1). The system then sends an e-mail to Barbara using the entered email address, instead of a message through the social network. The system permits Barbara to click a link in the e-mail to signal to the system to grant permission to Bill, or displays a user interface on a mobile app to Barbara that enables her to approve access for Bill. In this case, there is no social network connection between guest and owner, so the system sends the request directly to the owner's e-mail or mobile app, since it could not automatically pre-approve the guest by a recognized name. The system proceeds as in Use Case 1, so there is no need for Bill to type his e-mail address. Bill goes on Barbara's network, the network shows him the Facebook app, he clicks ok to authorize the app to examine his profile, the app determines that he has no friend relationship with Barbara, and finally notifies Barbara. Barbara can then approve network access to Bill, and the system so informs him. If Bill entered an e-mail address, the system authenticates it by requiring Bill to log into Facebook, obtain the e-mail address stored in Bill's Facebook account, and send it to Barbara, possibly with his (Guest's) photo, and offer Barbara the ability to grant access to Bill in this manner. This is an example of using a social network solely as an identity provider.

If the identity provider is not a social network (e.g. Yahoo), the system can use the identity alone to enable a subset of functionality. Since in that case, the system would not have access to a social graph, so it would not be able to automatically grant access to the network owner's friends, or friends of friends, and so on. However, it can still send the network owner an e-mail, to which she can respond to grant or deny guests network access manually, on a case by case basis.

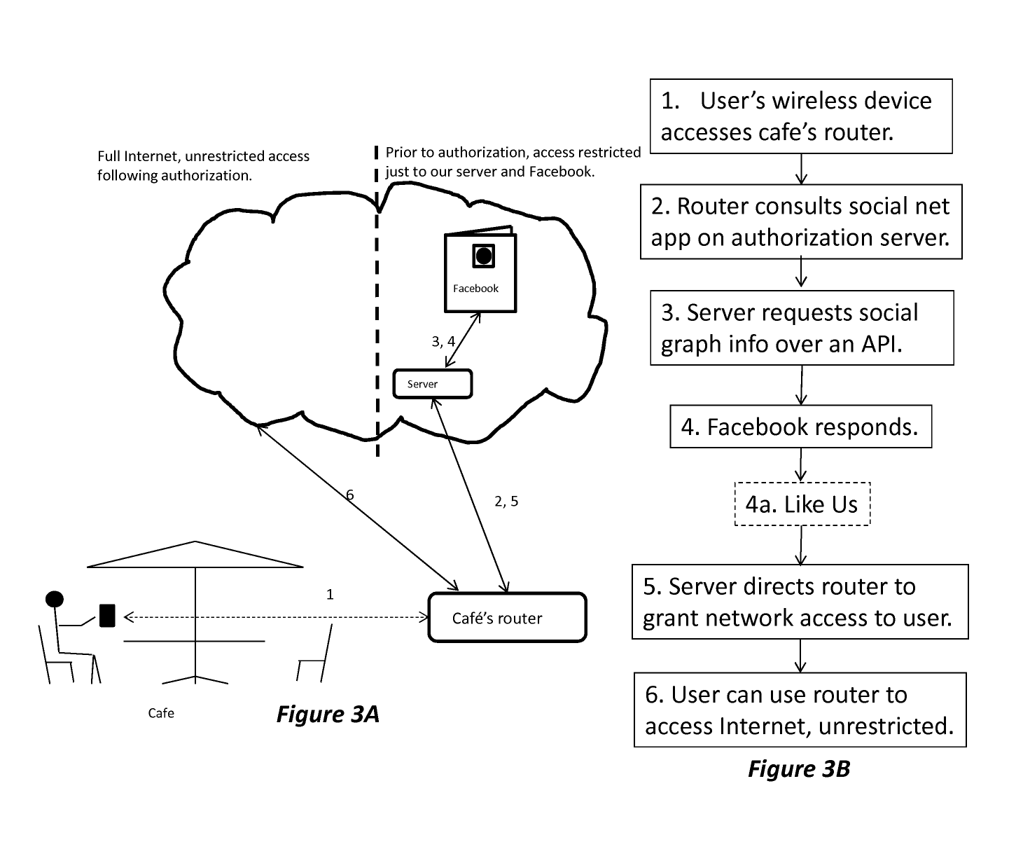

Use Case 4: The general scenario of Use Case 4 is illustrated in FIG. 3A, and the general flow of the process is illustrated in FIG. 3B. As shown in FIG. 3A, Bob visits a café. As above, Bob's first HTTP request redirects to a social network, where the app is deployed. This app automatically permits Bob immediate access because he has “liked” the café on Facebook. The technical details here are similar to Use Case 1, with appropriate modifications. In Step 1, the guest's mobile device sends an access request to the router. In Step 2 the router sends the request to the authorization server. In Step 3 the server operates an app that can use the appropriate Facebook API to access Bob's social graph, which includes his “likes.” The system proceeds as in Use Case 1, except that instead of checking a friend relationship, it checks if Bob has “liked” the café, as received in Step 4. In Optional Step 4a, if Bob has not yet “liked” the café, rather than simply denying him network access, the app may alternatively present Bob with a screen that offers him the opportunity to like (or “check in” at) the café right then, so that Bob has a path to network access, rather than automatically being denied. In Step 5 the server sends an authorization message to the router and in step 6 the router grants access to the Guest's device.

User Case 5: Jill is visiting a café. When she attempts to access the network, she is taken to Twitter and requested to follow the café's account on Twitter in order to gain access to the café's wireless network. Here again, the technical details are similar to Use Cases 1 and 4, with appropriate modifications.

Use Case 6: Sue goes to a restaurant and obtains network access in exchange for placing an order on the (electronic) menu of a restaurant. In this case, the menu may be hosted remotely or on the restaurant's router. The router may allow access for the menu, but not allow access to other pages. To gain access, she places the order, after which the router then gives access. Note that in this case, the router is pre-configured to do this, and no social network is used.

Use Case 7: This scenario is similar to Use Case 6 but with payment, i.e., a purchase of a menu item. Sue orders a drink or a meal from the menu. The router directs her to a website that enables her to pay her bill using a credit card or PayPal. After the purchase, the system directs the restaurant's router to enable Wi-Fi access to Sue. In this case, identity is ascertained either by logging onto a cloud service or the restaurant's website, and network access is granted on the basis of a customer relationship, not a social network relationship. Conversely, the Guest may pay for the item using near field communication (NFC), upon which the system authorizes the device to access the WiFi router.

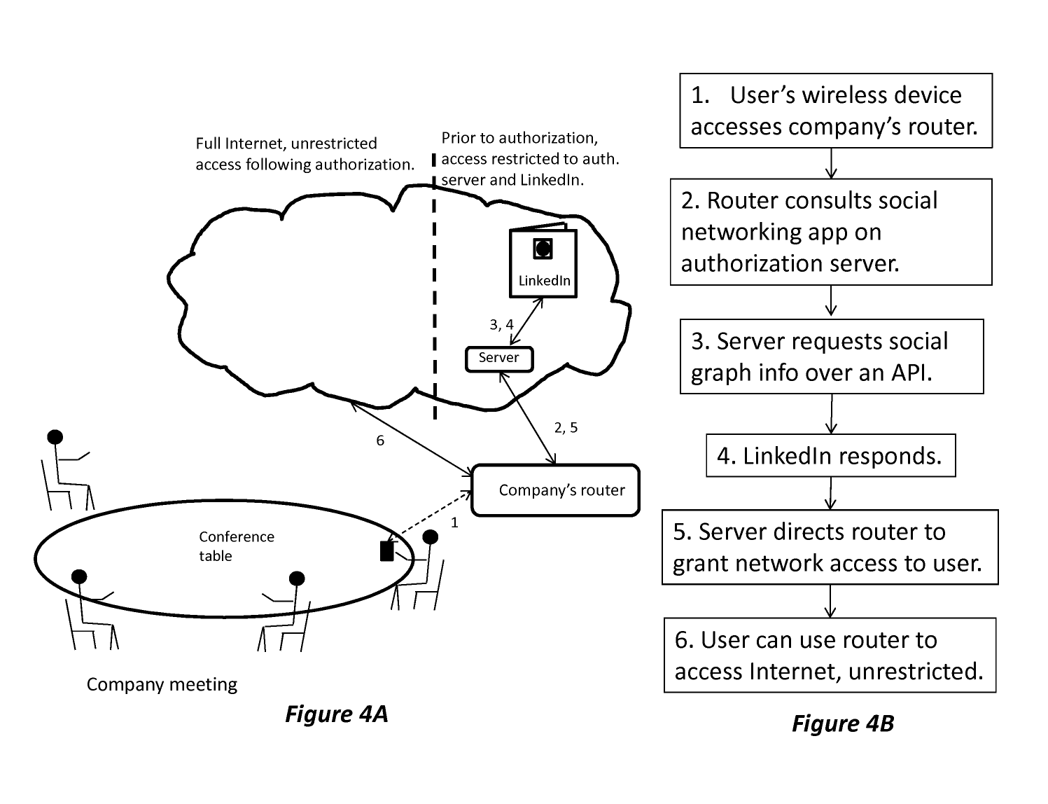

Use Case 8: The general scenario of Use Case 8 is illustrated in FIG. 4A, while the process is illustrated in FIG. 4B. Bill, a business visitor, comes to a meeting at a company for an appointment. Since the meeting has been entered into an electronic calendar, he is automatically given permission to access the network. This works as follows:

Bill has been invited to a meeting through an online calendar system, e.g., Outlook. His identity (in this case, his e-mail address) is in the meeting details, since that is how the invitation was send to him. When he arrives at the company, Bill attempts to join the network (Step 1), and is redirected to LinkedIn (Step 2) as he would have been redirected to Facebook in Use Case 1. If he is a LinkedIn user, he may be asked to approve access of the system's LinkedIn app to his profile. Once he does this, it authenticates Bill by seeing if the stored e-mail address in his LinkedIn account matches the e-mail address he used to receive the meeting invitation. If the system verifies his identity (Step 4), it grants him network access, pending (at the company's discretion) requiring Bill to accept terms and conditions. If the e-mail address stored at LinkedIn matches the e-mail address the company used to e-mail Bill the meeting invitation, he is admitted and given network access (Steps 5 and 6). It is not necessary for Bill to have been invited via LinkedIn; the system can still admit him automatically if he can prove his identity by logging into LinkedIn. Even if Bill was invited to the meeting with Google Calendar or Outlook, the system can look up his e-mail address to verify that he is same person.

The technical details are similar to previous use cases: the system intercepts his first HTTP request and redirects him to portal which asks him how he wants to sign into the network. He chooses LinkedIn. If the e-mail address he uses for LinkedIn matches the e-mail address used for the calendar invitation, the system authorizes him for network access.

Use Case 9: Paul visits a company for a last-minute meeting hosted by George. This case is similar to Use Case 8, but there is no authorization, since there was no scheduled appointment.

Instead, a request based on LinkedIn identity is sent to George, the meeting host. (This request must be sent to the meeting host, not to the system administrator, since the system administrator would not know about the meeting.) Therefore the guest needs to specify the meeting host's e-mail address. The host receives a request to authorize network access, which he then approves. Once the meeting host approves the guest's access, the guest gets an acknowledgement he has been approved and is now authorized for network access.

Use Case 10: Joe visits a business associate Ralph at Ralph's company. Joe and Ralph are linked on LinkedIn. LinkedIn verifies the professional connection on its network and authorizes network access for the time and place of the meeting. The authentication proceeds as described above in Use Case 1, and access can be granted either transparently to Joe, or request that Joe accept some terms and conditions for use of the network. Also, optionally, the access can be limited only to the duration of the meeting and terminated thereafter by revoking the guest's devices credentials.

### Additional Options Primarily for Residences (Use Cases 1-4)

The use cases listed above are not exhaustive. Disclosed methods permit numerous variations on the nature and quality of accountability and access control a network owner has over his network. If he chooses, he can automatically know the identity of each person using the network, the elapsed time of the connection, and the number of bytes downloaded and uploaded. He can also generate reports to verify this network usage. It is also possible to impose a variety of additional restrictions. For example, all his social network friends could have immediate unrestricted access. Alternatively, only household members might get full, unrestricted access to the network and its resources. A domestic partner may also be able to delegate this access. Access might be time-limited, for example, guests might be granted access only for the duration of their visit, and would need to request access again on a future visit. Guests might or might not be granted access to network resources such as printers or file servers. The network owner might set limitations on bandwidth or total data downloadable, or may set no limitations at all, but could prioritize his own traffic over his guest's. These restrictions may be applied in any combination in either in a case by case basis, or as preset rules (e.g. friends of owner get limited access to bandwidth but not to printers or file servers, or friends of friends get access, but only if the mutual friend is present, and so on. The service also can be configured to issue notifications to the owner of network usage either by e-mail, a mobile app, or social network messages.

From a user's perspective, one might come to a friend's house and, upon trying to connect to the owner's Wi-Fi network, see a request on Facebook.com, to allow Facebook Connect access to his profile info, and then proceed to use the network. Later, when visiting another friend who also uses the system, the user will simply be able to connect to the Wi-Fi network and authenticate completely without any user interaction. Here's what would happen technically: the user's browser would issue a request for some resource, say http://example.com. The Wi-Fi AP would intercept that and issue a redirect to, say, https://socialauthenticator.example.net/authenticate?next=http://example.com. The browser would have a cookie for socialauthenticator.example.net already from using the system at the first friend's house. The system will know from this cookie who the person is. It also knows already from Facebook Connect who the user's friends are and can, therefore, authorize the user as the network owner desires. Suppose the network owner allows 8-hour access to Facebook friends in any 24 hours. The system can then return this information to the Wi-Fi AP (out of band, for example, by hitting a REST API running on it), and redirect the user to http://example.com. Since the Wi-Fi AP has been instructed to pass this user's request through, it will no longer rewrite the browser's request and allow access to the site the user wanted. The user will simply see the site loading. The Wi-Fi AP can keep track of the user by MAC address or using any other means, such as the user's session key from WPA2 or other mechanisms. Using session keys to identify the user offers an advantage over the use of MAC addresses that it is much more secure, but necessitates more frequent authentication and authorization.

### Notes on Business-Specific Options (Use Cases 5-10)

Visitors to businesses are not “friends” with the business, per se, but the business can access who has “liked” them on the social network, and this “like” relationship may be sufficient.

This may not give access control, but gives accountability, in the same way a coffeehouse grants network access. Anyone can use the network, but the network owner, be it a café or other business, wants to ensure that network users “like” its Facebook page. This enables the café to know who is using the network. If there is ever a complaint of illegal network activity, the network owner can review the logs and determine who was doing it, i.e. this service provides accountability to the owner.

In other cases, the business may want access control, even for guests. In all cases, businesses want to know who is using the network and know that users have accepted terms and conditions of using it.

The user experience is also configurable. While home network owners might want to make access transparent, businesses often have legal requirements, and may therefore want to require their network users to agree to a set of terms and conditions. In addition, the business may want to promote itself through the use of Wi-Fi, e.g. “like” the page, view an ad, watch a video, order something from the menu in a restaurant or bar, and so on.

In some countries and jurisdictions, a network owner must know who uses his network, so that network abuse can be prosecuted (e.g. downloading illicit content or sending spam).

All of these cases can work with different social networks or other providers of identity and information, or some combination of them. The design choices of the user interface and experience are independent of the access control and authentication mechanism.

This system has the following features:
The network appears open to trusted users, who are not required to obtain passwords, but is in fact secured.
The network owner knows who uses his system without having to maintain an elaborate system of one-time passwords.
The network owner controls who accesses his network.
The network owner has accountability, since he can prove who did or did not use it in a given time period.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A method for automatically providing secure wireless network access, comprising:
receiving at a router a request for access from a requester;
sending the request from the router to an authorizing server;
at the authorizing server performing one of:
performing a social network inquiry to determine whether to authorize the request for access; or
sending an authorization request to an owner of the router; and,
receiving a response from the authorizing server and, when the response is an authorization, providing access to the requester, but when the response is denial, denying access.

2. The method of claim 1, wherein the authorization server performs social network inquiry by sending a request to a social network server.

3. The method of claim 1, wherein the authorization server performs social network inquiry by accessing a social network server via an API.

4. The method of claim 1, wherein the social network inquiry comprises social graph search.

5. The method of claim 1, wherein the social network inquiry comprises email address verification.

6. The method of claim 1, wherein the social network inquiry comprises determining whether the requester has posted a “like” indication.

7. The method of claim 1, wherein the social network inquiry comprises appointment calendar verification.

8. The method of claim 7, further comprising authorizing network access only to the duration of an appointment indicated on the calendar.

9. The method of claim 1, further comprising, transmitting to the requester a message inviting the requester to enter the requester's identity and an email address of the router's owner.

10. The method of claim 9, further comprising sending an email to the router owner enabling the network owner to allow or deny access to the requester.

11. A system for automatically providing wireless network access to an access point, comprising:
an authorization server connected to the Internet and running an authorization program;
an access point module running inside the access point;
wherein the authorization program is configured for performing the tasks comprising receiving an access request from the access point and performing on of:
performing a social network inquiry to determine whether to authorize the request for access; or
sending an authorization request to an owner of the router;
to determine whether to authorize the access and, when it determines that access should be authorize, sending an access authorization message to the router; and,
wherein the access point module is configured for performing the tasks comprising, upon receiving an access request from a new device, forwarding the request to the authorization server and, upon receiving the access authorization message from the authorizing server, granting Internet access to the new device.

12. The system of claim 11, wherein the authorization program is further configured to perform the tasks comprising upon receiving an access request, sending access inquiry message to a designated email address.

13. The system of claim 12, wherein the authorization program is further configured to perform the tasks comprising sending an email address request to the new device and, upon receiving an email address from the new device, considering the email address as the designated email address.

14. The system of claim 11, wherein the authorizing server is further configured to perform social network inquiry by accessing a social network server via an API.

15. The system of claim 11, wherein the authorizing server is further configured to request a social graph from Facebook server and use the social graph to determine whether a user associate with the new device is a “friend” of a user associate with the access point.

16. The system of claim 14, wherein the authorizing server is further configured to obtain a list of “likes” of a user associated with the new device and determine whether the list of likes include an entity associated with the access point.

17. The system 16, wherein the authorizing server is further configured to send a “like” request to the new device, asking user of the new device to “like” an entity associated with the access point.

18. The system of claim 11, wherein the authorizing server is further configured to perform social network inquiry by accessing an appointment calendar and determining whether an appointment for a user associated with the new device is indicated in the calendar.

19. The system of claim 18, wherein when an appointment is indicated, granting access for the duration of the appointment, and terminating the access after the duration of the appointment has passed.

20. The system of claim 11, wherein the authorizing server is configured to perform the social network inquiry to determine whether to provide the new device unrestricted access, restricted access, or no access, depending on level of social connection indicated in the social network between user associated with the new device and owner of the access point.
